(19) United States
(12) Patent Application Publication
(10) Pub. No.: US 2021/0142317 A1
(43) Pub. Date: May 13, 2021

(54) SYSTEMS AND METHODS FOR GLOBAL FINANCIAL TRANSACTION ROUTING

(71) Applicant: Wells Fargo Bank, N.A., San Francisco, CA (US)

(72) Inventors: H. Brock Kolls, Alpharetta, GA (US); Tambra Nichols, Charlotte, NC (US); Daniel Sanford, Charlotte, NC (US); Tosha Wesley, Charlotte, NC (US); Ximing Zhao, Charlotte, NC (US)

(21) Appl. No.: 15/654,889

(22) Filed: Jul. 20, 2017

(51) Int. Cl. G06Q 20/36; G06Q 20/12; G06Q 20/20; G06Q 20/22; G06Q 20/34

(52) U.S. Cl. CPC G06Q 20/36; G06Q 20/12; G06Q 20/351; G06Q 20/227; G06Q 20/204

(57) ABSTRACT

A system, method, and apparatus using a server system associated with an global network payment system, including a processor and a memory having instructions stored in non-transitory machine-readable media, the instructions executable by the processor, is provided. The server system is structured to generate a web-based payment card by appending a web-based payment card prefix corresponding to the global network payment system to an account number associated with a customer account. The server system is also structured to receive an electronic transaction record from a financial transaction router, wherein the electronic transaction record includes packaged web-based payment data, the packaged web-based payment data including at least the web-based payment card prefix and the account number comprised in the web-based payment card. The server system is further configured to identify a customer account based on the electronic transaction record and process a payment from the customer account.

### TECHNICAL FIELD

Embodiments of the present disclosure relate generally to the field of processing financial transactions.

### BACKGROUND

Many financial transactions are carried out by a customer using a payment card to make a purchase payment. The customer provides data about the payment card to a point-of-sale terminal, an online checkout system, etc., which provides the data about the payment card and information about the transaction to a financial transaction router. The financial transaction router determines where to route the transaction information based on the data about the payment card and transmits the transaction information accordingly. Eventually, the transaction information is received by a financial institution, which processes a payment for the financial transaction.

### SUMMARY OF THE INVENTION

One embodiment relates to a system for financial transaction processing. The system includes a server system associated with a global network payment system, including a processor and a memory having instructions stored in non-transitory machine-readable media, the instructions executable by the processor. The server system is structured to generate a web-based payment card by appending a web-based payment card prefix corresponding to the global network payment system to an account number associated with a customer account. The server system is also structured to receive an electronic transaction record from a financial transaction router, wherein the electronic transaction record is associated with a payment request from the customer as part of a financial transaction between the customer and a receiving party, and wherein the electronic transaction record includes packaged web-based payment data, the packaged web-based payment data including at least the web-based payment card prefix and the account number comprised in the web-based payment card. The server system is further structured to identify the customer account based on the electronic transaction record and process the payment from the customer account.

Another embodiment relates to a financial transaction routing method. The method includes generating, by a global network payment computing system, a web-based payment card by appending a web-based payment card prefix corresponding to the global network payment system to an account number associated with a customer account. The method also includes receiving, by the computing system, an electronic transaction record from a financial transaction router, wherein the electronic transaction record is associated with a payment request from the customer as part of a financial transaction between the customer and a receiving party, and wherein the electronic transaction record includes packaged web-based payment data, the packaged web-based payment data including at least the web-based payment card prefix and the account number comprised in the web-based payment card. The method further includes identifying, by the computing system, the customer account based on the electronic transaction record and processing, by the computing system, the payment from the account held by the customer.

Another embodiment relates to a system for financial transaction routing. The system includes a server system associated with a financial transaction router, including a processor and a memory having instructions stored in non-transitory machine-readable media, the instructions executable by the processor. The server system is structured to receive an electronic transaction record from one of a point-of-sale device or an online checkout system, wherein the electronic transaction record is associated with a payment request from a customer as part of a financial transaction between the customer and a receiving party, and wherein the electronic transaction record includes packaged web-based payment data, the packaged web-based payment data including at least a web-based payment card prefix corresponding to a global network payment system and an account number associated with a customer account. The server system is further structured to decode the web-based payment card prefix from the electronic transaction record, identify the global network payment system based on the web-based payment card prefix; and transmit the electronic transaction record to the global network payment system.

### BRIEF DESCRIPTION OF THE DRAWINGS

FIG. 1 is an environment view of a global financial transaction routing system, according to an example embodiment.

FIG. 2A illustrates example traditional payment card prefixes used to create traditional payment cards and web-based payment card prefixes used to create web-based payment cards for use with the system of FIG. 1.

FIG. 2B illustrates formats for packaged web-based payment data received from manual entry and from swiped entry, through the system of FIG. 1, according to example embodiments.

FIG. 2C illustrates a format for an electronic transaction record, created through the system of FIG. 1, according to an example embodiment.

FIG. 3 is a flow diagram illustrating a method of making a payment through the system of FIG. 1.

FIGS. 4A and 4B are graphical user interfaces shown to a user using a mobile wallet to make a payment with a web-based payment card, via the system of FIG. 1, according to an example embodiment.

### DETAILED DESCRIPTION

Referring to the Figures generally, various systems, methods, and apparatuses for providing a global financial transaction routing system are described herein. More particularly, systems and methods for using preexisting payment card transaction processing systems (e.g., using preexisting point-of-sale equipment, mobile wallets, and online transaction systems) to route transactions over the Internet to any server for payment processing are described herein.

With traditional payment cards (e.g., credit cards, debit cards), a transaction is typically processed as follows. When a customer uses a traditional payment card to pay for a transaction, an electronic transaction record is created (e.g., by a point-of-sale terminal, by a mobile wallet, by an online checkout system) that includes information about the transaction and “packaged payment data.” As used herein, packaged payment data refers to data about the payment card used to pay for a transaction that is gathered and packaged together when the customer makes a payment request using the payment card. The packaged payment data typically includes the number associated with the payment card (e.g., the credit card number, the debit card number), the beginning of which is an “issuer identification number” (“TIN”) associated with the financial institution that issued the payment card to the customer (e.g., the “issuer financial institution”). Additionally, the beginning digits of the TIN typically make up a “payment card prefix” that identifies the card type (e.g., whether the payment card is a MasterCard® payment card, a Visa® payment card, a Discover® payment card). For example, an TIN beginning in “6011” identifies the payment card as a card type A card, an TIN beginning in “4” identifies the payment card as a card type B card, and an TIN beginning in “51” identifies the payment card as a card type C card. The electronic transaction record is sent to one or more financial transaction routers that determine, based on the payment card prefix and/or the TIN, where to route the record for payment processing.

In one example, the electronic transaction record is sent to a financial institution (“acquirer financial institution”) associated with a merchant or other “receiving party” with which the customer is entering into the transaction. The acquirer financial institution routes the electronic transaction record to a computing system associated with the payment card type (“card network”) based on the payment card prefix. The card network then routes the electronic transaction record to the issuer financial institution based on the IIN.

The global financial transaction routing system described herein allows transaction payments from global network payment systems, such as online, digital, or virtual payment servers, rather than just through financial institutions as described above. Thus, an example implementation of the global financial transaction routing system is described as follows. A global network payment system first creates a “web-based payment card prefix.” As used herein, a “web-based payment card prefix” is an account prefix used in place of a traditional payment card prefix that corresponds to the global network payment system and instructs the financial transaction router to transmit information associated with a given transaction to the global network payment system. The global network payment system then uses the web-based payment card prefix to generate a “web-based payment card.” It should be understood that a “web-based payment card prefix” encompasses any prefix or other type of identifier that corresponds with a web-based, online, digital, or virtual payment processing system. Similarly, it should be understood that a “web-based payment card” encompasses any type of web-based, online, digital, or virtual payment device consistent with the systems and methods described herein. For example, the global network payment system appends the web-based payment card prefix to an account number, associated with a customer account, to create a web-based payment card associated with the global network payment system. In some arrangements, the web-based payment card is a multiple use-card with an expiration date (e.g., similar to a credit card), while in other arrangements, the web-based payment card is a single-use card (e.g., similar to a single-use voucher code). The global network payment system then embodies the web-based payment card in a physical implement (e.g., similar to a credit card), a global network-based database (e.g., a website), and/or a digital device (e.g., a mobile wallet on a smartphone) such that a customer can use the web-based payment card to pay for transactions using preexisting point-of-sale terminals, mobile wallets, and/or online transaction systems.

Accordingly, when the customer uses the web-based payment card to pay for financial transactions, the transaction payment is processed similarly to that of a traditional payment card. First, an electronic transaction record is created that includes information about the transaction (e.g., the financial transaction amount) and packaged payment data for the web-based payment card (e.g., the packaged payment data includes the web-based payment card prefix and the account number). As with a traditional payment card transaction, the electronic transaction record is then sent to a financial transaction router. The financial transaction router decodes the web-based payment card prefix from the electronic transaction record. However, unlike a traditional payment card prefix or an TIN, which directs the financial transaction router to send the electronic transaction record to a card network or a financial institution, the web-based payment card prefix directs the financial transaction router to send the electronic transaction record to the global network payment system associated with the web-based payment card. The global network payment system then identifies the customer based on the electronic transaction record (e.g., from the payment card data) and processes a payment for the transaction.

An advantage of the systems and methods for global network transactions described herein is that Internet-based payment systems are able to create payment cards that can be used with preexisting financial transaction processing systems and devices. Accordingly, any entity interested in processing financial transaction payments for customers can do so by encoding a web-based payment card prefix and creating web-based payment cards that include the web-based payment card prefix. No new equipment or routing systems are needed in order to allow customers to use these web-based payment cards to pay for transactions; rather, customers can use the web-based payment cards with preexisting point-of-sale terminals, mobile wallets, and online checkout systems.

Referring now to FIG. 1, an environmental view of a global financial transaction routing system 100 is shown, according to an example embodiment. As described in further detail below, the system 100 includes a point-of-sale device 102, a financial transaction routing computing system 104, one or more financial institution computing systems 106, and one or more global network payment computing systems 108 connected by a secure network (e.g., network 110).

The point-of-sale device 102 is a computing device associated with a merchant. Examples of merchants include retailers, wholesalers, marketplace operators, service providers (e.g., loan service providers, cleaning service providers, transportation providers), and so on. In operation, in response to a customer initiating a financial transaction with the point-of-sale device 102, the point-of-sale device 102 calculates the total amount owed by the customer for the given transaction, packages data about the customer's payment card used for the transaction, and creates an electronic transaction record. The electronic transaction record includes information about the transaction (e.g., the financial transaction amount, items being purchased in the transaction) for which the customer is requesting payment and the packaged payment data for the customer's payment card, which can either be a traditional payment card or a web-based payment card. The point-of-sale device 102 gathers and packages the data about the customer's payment card through various methods, such as by the customer swiping a magnetic stripe of a payment card through a magnetic stripe reader of the point-of-sale device 102, the customer inserting a chip of the payment card into a chip reader of the point-of-sale device 102, or the customer providing the data about the payment card through a mobile wallet (e.g., via near field communication (“NFC”)). However, it should be appreciated that the point-of-sale device 102 is an example device that creates an electronic transaction record as part of the global financial transaction routing system 100. In other embodiments, the electronic transaction record is instead created by other devices or computing systems. For example, in some arrangements, the electronic transaction record is instead created by an online checkout system. Additionally, in some embodiments, the point-of-sale device 102 is a single computing device (e.g., a point-of-sale terminal), while in other embodiments, multiple computing devices comprise the point-of-sale device 102 (e.g., a credit card reader connected to a smartphone or a tablet computer).

As shown in FIG. 1, in various embodiments, the point-of-sale device 102 includes a network interface 120, an input/output circuit 122, a display 124, and an electronic transaction record circuit 126. The network interface 120 includes program logic that facilitates connection of the point-of-sale device 102 to the network 110. Accordingly, the network interface 120 supports communication between the point-of-sale device 102 and other components of the system 100 via the network 110, such as between the point-of-sale device 102 and the financial transaction routing computing system 104.

The input/output circuit 122 is structured to receive from and provide communication(s) to a user of the point-of-sale device 102, such as a customer initiating a payment with a traditional payment card or a web-based payment card via the point-of-sale device 102 or an employee of the merchant associated with the point-of-sale device 102. In this regard, the input/output circuit 122 is structured to exchange data, communications, instructions, etc. with input/output components of the point-of-sale device 102. Accordingly, in various embodiments, the input/output circuit 122 includes an input/output device, such as a display, a magnetic stripe reader, a chip reader, an NFC device, or an infrared (“IR”) wireless receiver. In other embodiments, the input/output circuit 122 includes communication circuitry for facilitating the exchange of data, values, messages, and the like between an input/output device and the components of the point-of-sale device 102. In yet other embodiments, the input/output circuit 122 includes machine-readable media for facilitating the exchange of information between an input/output device and the components of the point-of-sale device 102. In still other embodiments, the input/output circuit 122 includes any combination of hardware components, communication circuitry, and machine-readable media.

In various embodiments, the display 124 is a screen, a touchscreen, a monitor, etc. In some arrangements, the point-of-sale device 102 uses the display 124 to communicate information to a user of the point-of-sale device 102 (e.g., by displaying the information to the user on the display 124). In other arrangements, the point-of-sale device 102 additionally uses the display 124 to receive communications from the user (e.g., through a keyboard provided on a touchscreen of the display 124). Accordingly, in certain arrangements, the display 124 is incorporated as an input/output device associated with the input/output circuit 122.

The electronic transaction record circuit 126 is configured to create an electronic transaction record for a given financial transaction initiated by a customer at the point-of-sale device 102. For example, the electronic transaction record circuit 126 creates an electronic transaction record in response to a customer and/or an employee of the merchant providing purchase information to and swiping a payment card (e.g., a traditional payment card, a web-based payment card) through the point-of-sale device 102. The electronic transaction record circuit 126 gathers data about the payment card, such as the payment card prefix (e.g., a traditional payment card prefix, a web-based payment card prefix) and the customer account number for the payment card, and packages the gathered data into packaged payment data. In some embodiments, the electronic transaction record circuit 126 generates packaged payment data similarly for traditional payment cards and web-based payment cards As an example, packaged payment data for a traditional card (“packaged traditional payment data”) is the same as packaged payment data for a web-based payment card (“packaged web-based payment data”). In other embodiments, the electronic transaction record circuit 126 creates packaged payment data that is different for traditional payment cards versus web-based payment cards. The electronic transaction record circuit 126 then generates an electronic transaction record for the financial transaction, including the packaged payment data, information about the goods and/or services being exchanged as part of the transaction, a transaction code, the amount of the financial transaction, and so on in the electronic transaction record. Accordingly, the electronic transaction record circuit 126 is further configured to receive payment card details and transaction information from the input/output circuit 122. In various embodiments, the electronic transaction record circuit also encrypts or otherwise protects the electronic transaction record. Once the electronic transaction record is created, the electronic transaction record circuit 126 is further configured to transmit the electronic transaction record to the financial transaction routing computing system 104.

The financial transaction routing computing system 104 is structured to receive generated electronic transaction records from the point-of-sale device 102 (e.g., from the electronic transaction record circuit 126), as well as from any other device or system capable of creating an electronic transaction record as part of system 100 (e.g., an online checkout system). In various embodiments, the financial transaction routing computing system 104 is associated with or operated by a financial institution (e.g., an acquirer financial institution), a card network, or any other entity involved in routing electronic transaction records. Additionally in some embodiments, the system 100 includes more than one financial transaction routing computing system 104, such as an acquirer financial institution and a card network. In practice, the financial transaction routing computing system 104 includes server computer systems, for example, comprising one or more networked computer systems.

As shown in FIG. 1, the financial transaction routing computing system 104 includes a network interface 130 and a processing circuit 132. The network interface 130 includes program logic that facilitates connection of the financial transaction routing computing system 104 to the network 110. Accordingly, the network interface 130 supports communication via the network 110 between the financial transaction routing computing system 104 and other components of the system 100 via the network 110, such as between the financial transaction routing computing system 104 and the point-of-sale device 102, the one or more financial institution computing systems 106, and/or the one or more global network payment computing systems 108.

The processing circuit 132 includes a processor 134, a memory 136, and a routing determination circuit 138. Additionally, as shown in FIG. 1, the financial transaction routing computing system 104 further includes a routing database 140. The routing database 140 is structured to retrievably store connections between transaction routing information, such as traditional and web-based payment card prefixes, and the associated receiving entities. For example, in various arrangements, the routing database 140 includes card types associated with payment card prefixes, financial institutions associated with IINs, and/or global network payment systems associated with web-based payment card prefixes. Examples of web-based payment card prefixes and their associated locations stored in the routing database 140 include Uniform Resource Locator (“URL”) addresses, Internet Protocol (“IP”) addresses, hexadecimal tokens representing URL or IP addresses, MD5 hashes encrypting URL or IP addresses, and/or other encrypted URL or IP addresses.

The routing determination circuit 138 is configured to determine where to route a given electronic transaction record received by the financial transaction routing computing system 104 from the point-of-sale device 102, a mobile wallet, an online checkout system, etc. In various embodiments, the routing determination circuit 138 decodes a received electronic transaction record to determine whether the packaged payment data included in the electronic transaction record includes a payment card prefix/IIN or a web-based payment card prefix. Upon decoding the payment card prefix/IIN or the web-based payment card prefix, the routing determination circuit 138 uses the routing database 140 to determine the card type associated with the payment card prefix, the issuer financial institution associated with the IIN, or the global network payment system associated with the web-based payment card prefix. The routing determination circuit 138 then transmits the electronic transaction record accordingly.

In one example, the financial transaction routing computing system 104 is a computing system associated with an acquirer financial institution. The routing determination circuit 138 receives an electronic transaction record from the point-of-sale device 102 and decodes packaged payment data in the electronic transaction record to determine that the record contains a payment card prefix/IIN. The routing determination circuit 138 then determines the card network associated with the payment card prefix in the routing database 140 and transmits the electronic transaction record to the associated card network, which then transmits the electronic transaction record to the issuer financial institution (e.g., associated with one of the financial institution computing systems 106) based on the TIN.

In another example, the routing determination circuit 138 receives an electronic transaction record from the point-of-sale device 102. The routing determination circuit 138 decodes packaged payment data in the electronic transaction record and determines that the record includes a web-based payment card prefix. As described in further detail below, the routing determination circuit 138 uses the web-based payment card prefix itself or the routing database 140 to determine the global network payment system (e.g., associated with one of the global network payment computing systems 108) associated with the web-based payment card prefix. The routing determination circuit 138 then transmits the electronic transaction record to the associated global network payment system.

Each of the one or more financial institution computing systems 106 is associated with or operated by a financial institution, such as a bank or a credit card issuer. In practice each financial institution computing system 106 includes server computer systems, for example, comprising one or more networked computer systems. For purposes of clarity, the financial institution computing system 106 is described as a single computing system, but it should be understood that multiple computing systems 106 may be part of the system 100.

As shown in FIG. 1, each financial institution computing system 106 includes a network interface 160 and a processing circuit 162. The network interface 160 includes program logic that facilitates the connection of the financial institution computing system 106 to the network 110. Accordingly, the network interface 160 supports communication via the network 110 between the financial institution computing system 106 and other components of the system 100 via the network 110, such as between the financial institution computing system 106 and the financial transaction routing computing system 104.

The processing circuit 162 includes a processor 164, a memory 166, and a payment processing circuit 168. As shown in FIG. 1, each financial institution computing system 106 further includes a financial institution accounts database 170. The financial institution accounts database 170 is structured to retrievably store account information for various customers of the financial institution associated with the financial institution computing system 106. For example, in various embodiments, the financial institution accounts database 170 stores biographical information for the customers of the financial institution, account types, account balances, account transaction histories, and customer account preferences.

The payment processing circuit 168 is configured to use an electronic transaction record received from the financial transaction routing computing system 104 to process a payment for the transaction. For example, in one embodiment, the payment processing circuit 168 identifies the account number of the customer requesting the transaction payment based on packaged payment data generated for a traditional payment card included in the electronic transaction record. The payment processing circuit 168 then authorizes a payment from the identified account (e.g., by sending an authorization notification to the point-of-sale device 102 and transferring the necessary funds to the acquirer financial institution). The payment processing circuit 168 is also configured to modify information stored in the financial institution accounts database 170 after processing a transaction payment, such as by modifying an account balance in the database 170 to reflect the payment made.

As shown in FIG. 1, the one or more global network payment computing systems 108 are structured similarly to the financial institution computing systems 106. However, instead of being associated with a financial institution, each global network payment computing system 108 is associated with or operated by a global network payment system. In various embodiments, a global network payment system includes any online payment system that processes transaction payments on the behalf of customers but is not associated with a preexisting payment card prefix, IIN, or card network. In one example, a global network payment system is an online rewards program operated by a merchant, whereby customers can exchange rewards points for purchases. In another example, a global network payment system is a loyalty program operated by a company through which the company will pay for certain goods or services purchases made by customers. In yet another example, a global network payment system is operated by a financial institution not associated with a payment card prefix, and the financial institution pays for purchases made by customers through accounts held by the customers at the financial institution. In a fourth example, a global network payment system is a gift card program, whereby one party can purchase a gift card or a voucher for a second party, and the second party can use the gift card or voucher to make a purchase. However, those of skill in the art will appreciate that these examples are not meant to be limiting. Rather, additional types or configurations of global network payment systems that allow customers to make purchases using web-based payment cards are envisioned. In practice, each global network payment computing system 108 includes server computer systems, for example, comprising one or more networked computer systems. For purposes of clarity, the global network payment computing system 108 is described as a single computing system, but it should be understood that multiple computing systems 108 may be part of the system 100.

As shown in FIG. 1, each global network payment computing system 108 includes a network interface 180 and a processing circuit 182. The network interface 180 includes program logic that facilitates the connection of the global network payment computing system 108 to the network 110. Accordingly, the network interface 180 supports communication via the network 110 between the global network payment computing system 108 and other components of the system 100 via the network 110, such as between the global network payment computing system 108 and the financial transaction routing computing system 104.

The processing circuit 182 includes a processor 184, a memory 186, and a payment processing circuit 188. As shown in FIG. 1, each global network payment computing system 108 further includes a global network payment system accounts database 190. The global network payment system accounts database 190 is structured to retrievably store account information for various customers of the global network payment system. In various embodiments, these customer accounts include financial accounts, loyalty accounts, rewards accounts, voucher or coupon accounts, and so on. For example, in one embodiment, the global network payment system accounts database 190 stores rewards information for various customers, including purchases each customer has made from a merchant associated with the given global network payment system. In another embodiment, the global network payment system accounts database 190 stores loyalty information for various customers, such as biographical information for each customer, each customer's spending habits, and how each customer has promoted a company associated with the global network payment system (e.g., on social media). In yet another embodiment, the global network payment system accounts database 190 is similar to the financial institution accounts database 170, storing biographical information for the customers of the global network payment system, account types, account balances, account transaction histories, and customer account preferences. In still another embodiment, the global network payment system accounts database 190 stores unused gift card amounts or unused vouchers that have been pre-purchased for various customers.

The payment processing circuit 188 is configured to use an electronic transaction record received from the financial transaction routing computing system 104 to process a payment for the transaction. In various embodiments, the payment processing circuit 188 identifies a customer account number from the electronic transaction record (e.g., from the packaged web-based payment data in the electronic transaction record). The payment processing circuit 188 also identifies information about the transaction, such as the amount of the transaction and what the transaction is for, from the electronic transaction record. The payment processing circuit 188 then determines whether the customer account has the necessary account funds, gift card funds, rewards points, vouchers, and so on to cover the payment for the transaction. If the customer does, the payment processing circuit 188 authorizes a payment for the transaction (e.g., by sending an authorization notification to the point-of-sale device 102 and transferring the necessary funds to the acquirer financial institution). If the customer does not, the payment processing circuit 188 does not authorize a payment for the transaction (e.g., by sending an error message to the point-of-sale device 102 and cancelling the transaction). The payment processing circuit 188 is also configured to modify account information stored in the global network payment system accounts database 190 (e.g., modify an account balance and/or modify one or more digital rewards items, such as rewards points, loyalty points, or vouchers, in the customer's account) in response to authorizing the transaction payment.

For example, if the global network payment system is a rewards system, the payment processing circuit 188 determines whether the customer has enough rewards points to exchange with the global network payment system based on a predetermined rewards-to-purchases system such that the global network payment system will pay for the requested transaction. If the customer has enough points to exchange for the transaction, the payment processing circuit 188 authorizes a payment for the transaction (e.g., from a financial account associated with the global network payment system). As another example, if the global network payment system is a loyalty system that provides vouchers to customers, the payment processing circuit 188 determines whether the customer account has a voucher for all or part of the requested transaction. If the customer does have the necessary voucher, the payment processing circuit 188 authorizes a payment for the covered part of the transaction (e.g., from a financial account associated with the global network payment system). As a third example, if the global network payment system is a financial institution with customer financial accounts, the payment processing circuit 188 processes a payment similarly to the payment processing circuit 168 of the financial institution computing system 106.

In each of these examples, the payment processing circuit 188 then modifies account information (e.g., an account balance, one or more digital rewards items) stored in the global network payment system accounts database 190 to reflect that the payment was made. For example, the payment processing circuit 188 modifies an account balance to reflect that a payment was made from the customer account, modifies a rewards points balance to reflect that rewards points were redeemed from the customer account, modifies a voucher status to reflect that a voucher was redeemed from the customer account, and so on. Additionally, in some embodiments, the payment processing circuit 188 modifies account information stored in the global network payment system accounts database 190 to reflect that the customer has earned one or more rewards items through the transaction. For example, the payment processing circuit 188 modifies a rewards points balance to reflect rewards points earned from the transaction, adds a voucher earned from the transaction to the customer's account, and so on.

Furthermore, in some embodiments, the payment processing circuit 188 is configured to detect when a payment request is fraudulent. In one example, the payment processing circuit 188 includes fraud detection logic capable of determining when a payment request is fraudulent based on the conditions surrounding the transaction associated with the payment request (e.g., if the transaction is taking place in a different country and the customer has never been abroad, the fraud detection logic determines that the payment request is fraudulent). In other embodiments, the global network payment computing system 108 includes an additional circuit configured for payment request fraud controls.

Referring now to FIG. 2A, example payment card prefixes used to create traditional payment cards and web-based payment card prefixes used to create web-based payment cards are shown in table 200, according to example embodiments. The top prefixes 202 shown in table 200 include example payment card prefixes used for traditional payment cards. For example, as shown in FIG. 2A, the prefix “6011” indicates that a payment card is a card type A card, the prefix “4” indicates that the payment card is a card type B card, and the prefixes “51,” “52,” “53,” and “54” indicate that the payment card is a card type C card.

By contrast, the bottom prefixes 204 shown in table 200 include examples of web-based payment card prefixes that can be used with the system 100. Web-based payment card prefixes 206 and 208 illustrate examples of URL address prefixes. Web-based payment card prefix 206 is the URL address “Retailer.com,” which, as shown in table 200, corresponds with the global network payment system “Retailer.com.” Web-based payment card prefix 208 is the URL address “Wholesaler.com/CardAuth,” which corresponds with the global network payment system “Wholesaler.com.” Web-based payment card prefix 210 illustrates an example of an IP address prefix; web-based payment card prefix 210 is the IP address “71.43.56.23,” which corresponds with the global network payment system “Loyalty.com.” Finally, web-based payment card prefix 212 illustrates an example of a hexadecimal token prefix. Web-based payment card prefix 212 is the hexadecimal token “3FE42A,” which in table 200 corresponds with the global network payment system “Merchant.com.” However, those of skill in the art will appreciate that additional types of web-based payment card prefixes are also envisioned by this application, such as one-way encrypted URL and/or IP addresses (e.g., encrypted as an MD5 hash, which is matched in a look-up table that contains a corresponding URL or IP address).

Table 200 further represents example information stored in the routing database 140 of the financial transaction routing computing system 104 and used by the routing determination circuit 138 to determine where to route a received electronic transaction record. For example, if the routing database 140 includes table 200, the routing determination circuit 138 could determine that, given an electronic transaction record including a web-based payment card prefix of 3FE42A, the electronic transaction record should be routed to Merchant.com. Similarly, given an electronic transaction record including a traditional payment card prefix of 4, the routing determination circuit 138 can use the table 200 to determine that the electronic transaction record should be routed to the card network associated with card type B.

Referring now to FIG. 2B, formats for packaged web-based payment data created as part of a transaction and included in an electronic transaction record are shown, according to example embodiments. Format 220 illustrates an example of packaged web-based payment data created through manual entry. With manual entry, a party (e.g., a customer or an employee of a merchant) manually enters information regarding the web-based payment card. For example, in one arrangement, the web-based payment card is embodied as a physical implement with the web-based payment card prefix and customer account number printed on the front or the back of the physical implement, similar to a credit card or a debit card. Manual entry data for the web-based payment card is thus created from a party manually typing of the web-based payment card prefix and customer account number printed on the physical implement into, for example, the point-of-sale device 102 or into a payment section in an online checkout system. In another arrangement, the web-based payment card is not embodied in a physical implement. Instead, the customer is electronically sent (e.g., by email, by a text message) the web-based payment card. The customer then types or copies the web-based payment card into, for example, the point-of-sale device 102 or a payment section in an online checkout system to complete a purchase. Regardless, when the point-of-sale device 102 or online checkout system receives the manual entry data, the point-of-sale device 102 or system packages the manual entry data into packaged web-based payment data in the manual entry format 220 and determines where to route the transaction based on the web-based payment card prefix included in the manual entry data.

As shown in FIG. 2B, the manual entry format 220 includes a web-based payment card prefix field 222 followed by an account number field 224. Thus, the manual entry format 220 is similar to the format used for a traditional payment card number, with an IIN followed by an account number. The web-based payment card prefix field 222 includes a web-based payment card prefix that corresponds with the global network payment system issuing the web-based payment card, such as any of web-based payment card prefixes 206-212. The account number field 224 includes an account number that identifies the customer account associated with the web-based payment card. In various arrangements, as discussed above, the account number is also stored in the global network payment system accounts database 190.

Format 230 illustrates an example of packaged web-based payment data created by swiping a physical implement embodying the web-based payment card via the point-of-sale device 102. For example, packaged web-based payment data in format 230 is generated by swiping a magnetic stripe of the physical implement of the web-based payment card, with information about the web-based payment card encoded on the magnetic stripe, through a magnetic stripe reader of the point-of-sale device 102. Alternatively, packaged web-based payment data in format 230 is created by inserting a chip of the physical implement, with information about the web-based payment card stored on the chip, into a chip reader of the point-of-sale device 102.

The swiped entry format 230 includes a web-based payment card prefix field 232, an account number field 234, a separator 236, and an “other information” field 238. The web-based payment card prefix field 232 includes a web-based payment card prefix identifying the global network payment system associated with the web-based payment card and is formatted similarly to the web-based payment card prefix field 222. Similarly, the account number field 234 includes an account number corresponding to a customer account associated with the web-based payment card and is formatted similarly to the account number field 224. The other information field 238 includes other relevant information about the web-based payment card, such as an expiration date of the web-based payment card. Accordingly, the swiped entry format 230 includes more fields than the manual entry format 220.

However, those of skill in the art will appreciate that the manual entry format 220 and the swiped entry format 230 are example formats. In other embodiments, the manual entry format 220 and/or the swiped entry format 230 have different orders and/or include additional or different sections. For example, in one embodiment, the format 220 and/or the format 230 have checksum digit sections. In another embodiment, the swiped entry format 230 is in track 1 or track 2 format. Additionally, in various embodiments, some or all of the packaged web-based payment data included in formats 220 and 230 is replaced by a payment token.

Referring now to FIG. 2C, a format 240 for an electronic transaction record is shown, according to an example embodiment. As described above, an electronic transaction record is created when a customer requests a payment for a transaction, using a payment card, through a point-of-sale terminal (e.g., point-of-sale device 102), through an online checkout system, etc. As shown, the electronic transaction record format 240 includes a packaged payment data section 242, an authorization/sales/settlement detail section 244, a transaction code section 246, and an “other information” section 248. The packaged payment data section 242 includes packaged traditional payment data or packaged web-based payment data, such as packaged web-based payment data in manual entry format 220 or swiped entry format 230. The authorization/sales/settlement detail section 244 includes information about the transaction for which the customer requested a payment using the traditional or web-based payment card. In one example, the authorization/sales/settlement detail section 244 includes information about the financial transaction amount (e.g., the purchase price of the transaction), what is being purchased in the transaction, and from whom the purchase is being made. The transaction code section 246 includes an alphanumeric character representing the type of transaction being made. As an example, the transaction code “AA” represents a pre-authorization, the transaction code “BB” represents a sale, and the transaction code “CC” represents a settlement. Finally, the other information section 248 includes any necessary and additional information about the transaction. For example, in various embodiments, the other information section 248 includes a unique identifier of the transaction. Additionally, those of skill in the art will appreciate that the electronic transaction record format 240 is an example format. In other embodiments, the electronic transaction record format has a different order and/or includes additional or different sections.

Referring now to FIG. 3, a method of making a payment using a web-based payment card with the system 100 is illustrated. Process 300A illustrates the method of making a payment using a web-based payment card from the perspective of one of the global network payment computing systems 108, and process 300B illustrates the method of making a payment using the web-based payment card from the perspective of the financial transaction routing computing system 104.

Referring first to process 300A, a web-based payment card prefix is created at 302. The web-based payment card prefix corresponds to the global network payment computing system 108 and directs electronic transactions to the global network payment computing system 108 (e.g., the web-based payment card prefix is one of the prefixes shown in table 200). In some embodiments, the web-based payment card prefix itself directs that an electronic transaction record containing the web-based payment card prefix be sent to the global network payment computing system 108, such as where the prefix is a URL or IP address. In other embodiments, the global network payment computing system 108 transmits the web-based payment card prefix and the prefix's connection to the global network payment computing system 108 to the financial transaction routing computing system 104 to be stored in the routing database 140. For example, the global network payment computing system 108 creates a hexadecimal code and transmits the code to the financial transaction routing computing system 104 to be stored in the routing database 140 in association with the global network payment computing system 108. In this way, the financial transaction routing computing system 104 can use the routing database 140 to determine that an electronic transaction record containing the hexadecimal code should be routed to the global network payment computing system 108.

A web-based payment card is generated using the web-based payment card prefix at 304. In various embodiments, the global network payment computing system 108 generates a web-based payment card for a given customer by appending an account number, associated with an account held by the customer (e.g., with the global network payment system), after the web-based payment card prefix. In other embodiments, the global network payment computing system 108 includes additional information in the web-based payment card, such as an expiration date for the web-based payment card or a checksum digit for the card. In some arrangements, the web-based payment card is generated to multiple uses, while in other arrangements, the web-based payment card is generated for a single use.

The web-based payment card is then embodied in a physical implement, a global network-based database, and/or a digital device at 306. In one embodiment, the global network payment computing system 108 issues a physical implement of the web-based payment card to the customer associated with the web-based payment card (e.g., similar to a credit card or a debit card). The customer can then use the physical implement to make purchases using point-of-sale terminals (e.g., using the point-of-sale device 102). In another embodiment, the global network payment computing system 108 stores the web-based payment card in a “global network-based database,” or a database associated with the global financial transaction routing system 100. In some arrangements, after storing the web-based payment card in a global network-based database, the global network payment computing system 108 sends the web-based payment card (e.g., in the manual entry format 220) to the associated customer. For example, the global network payment computing system 108 transmits the web-based payment card to the customer through an email or a text message such that the customer is able to use the data to make purchases. In yet another embodiment, the global network payment computing system 108 embodies the web-based payment card on a digital device, such as on a mobile wallet of the customer's smartphone. The customer is then able to make purchases using the web-based payment card through the digital device. Accordingly, once the global network payment computing system 108 embodies the web-based payment card in some form, the customer associated with the web-based payment card is able to use the embodied payment card to make purchases, either through the point-of-sale device 102 or through an online checkout system.

Additionally, in some embodiments, the global network computing system 108 is able to automatically electronically renew, reactivate, or upgrade an embodied web-based payment card. As an example, if the web-based payment card is embodied as a digital code that is sent to the customer, the global network computing system 108 automatically sends a new digital code representing the web-based payment card to the customer when the original code expires. Furthermore, in certain embodiments, the global network computing system 108 is able to automatically deactivate the web-based payment card. As another example, if the web-based payment card is embodied on a mobile wallet of a mobile device associated with the customer and the customer's mobile device is stolen, upon the customer notifying the global network computing system 108 that the customer's mobile device was stolen, the global network computing system 108 deactivates the web-based payment card. Further, if the customer registers a new mobile device with the global network computing system 108, the computing system 108 automatically generates a new web-based payment card for the new mobile device.

Referring next to process 300B, an electronic transaction record, including web-based payment card data, is received at 308. As discussed above, the electronic transaction record is created by a customer using the web-based payment card to request a purchase payment for a transaction (e.g., using the point-of-sale device 102, using an online checkout system) as part of a financial transaction between the customer and a receiving party (e.g., a merchant). As discussed, in various arrangements, the electronic transaction record includes packaged payment data (e.g., packaged web-based payment data in a manual entry format 220 or a swiped entry format 230) and purchase information (e.g., the financial transaction amount). The electronic transaction record is then sent to and received by the financial transaction routing computing system 104.

The web-based payment card prefix is decoded from the electronic transaction record at 310. Accordingly, the routing determination circuit 138 of the financial transaction routing computing system 104 determines whether the electronic transaction record contains a traditional payment card prefix/IIN or a web-based payment card prefix. Upon determining that the electronic transaction record includes a web-based payment card prefix, the routing determination circuit 138 uses the web-based payment card prefix to determine where to route the electronic transaction record (e.g., which of the one or more global network payment computing systems 108 to route the electronic transaction record to). In one embodiment, the routing determination circuit 138 determines where to route the electronic transaction record based on the web-based payment card prefix itself. For example, if the web-based payment card prefix is a URL address, the routing determination circuit 138 knows to route the electronic transaction record to the URL address. In another embodiment, the routing determination circuit 138 determines where to route the electronic transaction record by finding the global network payment system associated with the web-based payment card prefix in a look-up table stored in the routing database 140. For example, if the web-based payment card prefix is an MD5 hash of a URL address, the routing determination circuit 138 finds the URL address corresponding to the MD5 hash in the routing database 140.

The electronic transaction record is routed to the associated global network payment computing system 108 based on the web-based payment card prefix at 312. Accordingly, referring back to process 300A, the electronic transaction record is received from the financial transaction routing computing system at 314. Thus, the financial transaction routing computing system 104 transmits the electronic transaction record to the global network payment computing system 108 the computing system 104 determines to be associated with the decoded web-based payment card prefix, and the global network payment computing system 108 receives the transmitted electronic transaction record.

Finally, the transaction payment is processed at 316. In doing this, the payment processing circuit 188 of the global network payment computing system 108 uses the electronic transaction record (e.g., the packaged payment data included in the electronic transaction record) to identify the account of the customer who used the web-based payment card. The payment processing circuit 188 then authorizes a payment for the transaction based on the identified account. As discussed above, in some arrangements, the payment processing circuit 188 authorizes the payment from a financial account held by the customer with the global network payment system (e.g., transfers funds from the customer's financial account to an account associated with the receiving party in the financial transaction). The payment processing circuit 188 subsequently modifies an account balance for the customer's account in the global network payment system accounts database 190. In other arrangements, the payment processing circuit 188 checks the customer account (e.g., as reflected in the global network payment system accounts database 190) to determine whether the customer has a required number of rewards points, loyalty points, vouchers, or so on to exchange with the global network payment system to cover the requested transaction. If the customer does, the payment processing circuit 188 modifies the customer's account balance in the database 190 and authorizes the payment from a payment account associated with the global network payment system (e.g., transfers funds from the payment account associated with the global network payment system to an account associated with the receiving party in the financial transaction).

Referring now to FIGS. 4A and 4B, example graphic user interfaces shown to a customer using a mobile wallet 400 on a mobile device 402 to make a payment with a web-based payment card, via the system 100, are depicted according to an example embodiment. FIG. 4A illustrates a payment selection screen 404 shown to a customer who has initiated a transaction payment using the mobile wallet 400. The payment selection screen 404 includes a carousel 406 showing the payment cards that the customer has included in the customer's mobile wallet 400. In the example of FIG. 4A, the carousel 406 includes a traditional payment card A 408, a traditional payment card B 410, and a web-based payment card A. Additionally, the payment selection screen 404 includes web-based payment card B 414, which is shown separate from the carousel 406 because the customer has selected as the payment card to be used to make the transaction payment. The depiction of the web-based payment card B 414 also includes a card number section 416 that shows the last four digits of the web-based prefix and customer account for web-based payment card B 414. Accordingly, the customer can identify web-based payment card B 414 from the last four digits shown, but onlookers cannot determine the entirety of the web-based prefix and customer account for web-based payment card B 414.

As shown, each of the payment cards 408, 410, 412, and 414 is depicted similarly to a physical implement of a payment card (e.g., similar to a physical credit card or a physical debit card). However, those of skill in the art will appreciate that, in other embodiments, one or more of the payment cards included in the mobile wallet 400 are depicted differently. For example, in one embodiment, traditional payment card A 408 is depicted in the mobile wallet 400 similarly to the physical implement of traditional payment card A 408, and traditional payment card B 410 is depicted similarly to the physical implement of the traditional payment card B 410. Conversely, web-based payment card A 412 and web-based payment card B 414 are listed as payment options under a separate web-based payment card section.

FIG. 4B illustrates a payment confirmation screen 420 shown to the customer after successfully making a transaction payment using web-based payment card B 414. The payment confirmation screen 420 also includes a “view receipt” button 422 that the customer can press to view the receipt for the transaction.

Those of skill in the art will appreciate, however, the FIGS. 4A and 4B illustrate example embodiments of graphical user interfaces presented to a customer making a payment with a web-based payment card, via the system 100, using a mobile wallet. FIGS. 4A and 4B are not meant to be limiting. Moreover, in certain embodiments, additional or alternative graphical user interfaces are presented to the customer as part of making a payment with a web-based payment card via the system 100 described herein and using a mobile wallet.

The embodiments described herein have been described with reference to drawings. The drawings illustrate certain details of specific embodiments that implement the systems, methods and programs described herein. However, describing the embodiments with drawings should not be construed as imposing on the disclosure any limitations present in the drawings.

It should be understood that no claim element herein is to be construed under the provisions of 35 U.S.C. § 112(f), unless the element is expressly recited using the phrase “means for.”

As used herein, in various embodiments, the term “circuit” includes hardware structured to execute the functions described herein. In some embodiments, each respective “circuit” includes machine-readable media for configuring the hardware to execute the functions described herein. The circuit is embodied as one or more circuitry components including, but not limited to, processing circuitry, network interfaces, peripheral devices, input devices, output devices, sensors, etc. In some embodiments, a circuit takes the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” includes any type of component for accomplishing or facilitating achievement of the operations described herein. In one example, a circuit as described herein includes one or more transistors, logic gates (e.g., NAND, AND, NOR, OR, XOR, NOT, or XNOR), resistors, multiplexers, registers, capacitors, inductors, diodes, wiring, and so on.

In other embodiments, the “circuit” includes one or more processors communicably coupled to one or more memories or memory devices. In this regard, the one or more processors execute instructions stored in the memory or execute instructions otherwise accessible to the one or more processors. In various arrangements, the one or more processors are embodied in various ways and are constructed in a manner sufficient to perform at least the operations described herein. In some embodiments, the one or more processors are shared by multiple circuits (e.g., circuit A and circuit B comprise or otherwise share the same processor which, in some example embodiments, executes instructions stored, or otherwise accessed, via different areas of memory). Additionally, in various arrangements, a given circuit or components thereof (e.g., the one or more processors) are disposed locally (e.g., as part of a local server or a local computing system) or remotely (e.g., as part of a remote server such as a cloud based server). To that end, in certain arrangements, a “circuit” as described herein includes components that are distributed across one or more locations.

As used herein, a processor is implemented as a general-purpose processor, an application specific integrated circuit (ASIC), one or more field programmable gate arrays (FPGAs), a digital signal processor (DSP), a group of processing components, or other suitable electronic processing components. Additionally, in some arrangements, a “processor,” as used herein, is implemented as one or more processors. In certain embodiments, the one or more processors are structured to perform or otherwise execute certain operations independent of one or more co-processors. In other example embodiments, two or more processors are coupled via a bus to enable independent, parallel, pipelined, or multi-threaded instruction execution. In some arrangements, the one or more processors take the form of a single core processor, multi-core processor (e.g., a dual core processor, triple core processor, or quad core processor), microprocessor, etc. In some embodiments, the one or more processors are external to the apparatus, for example, the one or more processors are a remote processor (e.g., a cloud based processor). Alternatively, or additionally, the one or more processors are internal and/or local to the apparatus. Accordingly, an exemplary system for implementing the overall system or portions of the embodiments might include a general purpose computing computers in the form of computers, including a processing unit, a system memory, and a system bus that couples various system components including the system memory to the processing unit.

Additionally, as used herein, a memory includes one or more memory devices including non-transient volatile storage media, non-volatile storage media, non-transitory storage media (e.g., one or more volatile and/or non-volatile memories), etc. In some embodiments, the non-volatile media takes the form of ROM, flash memory (e.g., flash memory such as NAND, 3D NAND, NOR, or 3D NOR), EEPROM, MRAM, magnetic storage, hard discs, optical discs, etc. In some embodiments, the volatile storage media takes the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. In various arrangements, each respective memory device is operable to maintain or otherwise store information relating to the operations performed by one or more associated circuits, including processor instructions and related data (e.g., database components, object code components, or script components), in accordance with the example embodiments described herein.

It should be understood that a “network interface,” as used herein, includes any of a cellular transceiver (Code Division Multiple Access (CDMA), Global System for Mobile Communications (GSM), Long-Term Evolution (LTE), etc.), a wireless network transceiver (e.g., 802.11X, ZigBee, or Bluetooth), or a combination thereof (e.g., both a cellular transceiver and a Bluetooth transceiver). In some arrangements, a network interface includes hardware and machine-readable media sufficient to support communication over multiple channels of data communication. Further, in some arrangements, the network interface includes cryptography capabilities to establish a secure or relatively secure communication session between the device including the network interface and other devices of the system 100 via the network 110. In this regard, personal information about clients, financial data, and other types of data is encrypted and transmitted to prevent or substantially prevent the threat of hacking.

In certain embodiments, an “input/output device” as used herein includes hardware and associated logics configured to enable a party to exchange information with a computing device to which the input/output device is connected. In various embodiments, an input aspect of an input/output device allows a user to provide information to the computing device and includes, for example, a touchscreen, a mouse, a keypad, a camera, a scanner, a fingerprint scanner, an eye scanner, a sensor that detects movement, a microphone, a joystick, a user input device engageable to the computing device via a USB, wirelessly, and so on, or any other type of input device capable of being used with a computing device. In various embodiments, an output aspect of an input/output device allows a party to receive information from the computing device and includes, for example, a display, a printer, a speaker, illuminating icons, LEDs, an output device engageable to the computing device via a USB, wirelessly, and so on, or any other type of output device capable of being used with a computing device.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein show a specific order and composition of method steps, it is understood that in various embodiments the order of these steps differs from what is depicted. As an example, two or more steps are performed concurrently or with partial concurrence. Also, in various embodiments, some method steps that are performed as discrete steps are combined, steps being performed as a combined step are separated into discrete steps, the sequence of certain processes is reversed or otherwise varied, and/or the nature or number of discrete processes is altered or varied. Furthermore, the order or sequence of any element or apparatus is varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques, with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or as acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions can be made to the design, operating conditions and arrangement of the embodiments without departing from the scope of the present disclosure as expressed in the appended claims.

1. A system for financial transaction processing, comprising:
a server system associated with a global network payment system, including a processor and a memory having instructions stored in non-transitory machine-readable media, wherein the global network payment system is operated by a merchant with which a customer has a preexisting relationship, wherein the global network payment system is not associated with an issuer identification number, and wherein the instructions are executable by the processor to:
generate a web-based payment card by appending a web-based payment card prefix corresponding to a URL address associated with the global network payment system to an account number associated with a customer account that the customer holds with the merchant;
receive, via the URL address, an electronic transaction record routed to the URL address from a financial transaction router, wherein the web-based payment card prefix directs the financial transaction router to route the electronic transaction record to the URL address, wherein the electronic transaction record is associated with a payment request from a customer associated with the customer account as part of a financial transaction between the customer and the merchant, and wherein the electronic transaction record includes packaged web-based payment data, the packaged web-based payment data including at least the web-based payment card prefix and the account number comprised in the web-based payment card;
identify the customer account based on the electronic transaction record; and
process the payment request from the customer account based on the electronic transaction record routed to the URL address.

2. The system of claim 1, wherein the customer can use the web-based payment card to make payments with preexisting payment card transaction systems.

3. The system of claim 1, wherein the web-based payment card prefix is one of the URL address, an IP address, a hexadecimal code, an encrypted URL address, or an encrypted IP address.

4. The system of claim 1, wherein the server system is further configured to embody the web-based payment card in at least one of a physical implement, a database, or a digital device, wherein the customer can use the embodied web-based payment card to make payments with preexisting payment card transaction systems.

5. The system of claim 1, wherein the customer account is a financial account, and wherein the server system processes the payment from the customer account by:
transmitting a payment authorization to one of a point-of-sale device or an online checkout system used by the customer to request the payment; and
transferring funds from the customer account to an account held by the receiving party.

6. The system of claim 1, wherein the customer account is a rewards account containing one or more digital rewards items, and wherein the server system processes the payment from the customer account by:
transmitting a payment authorization to one of a point-of-sale device or an online checkout system used by the customer to request the payment;
modifying one or more digital rewards items in the customer account; and
transferring funds from an account associated with the server system or the customer account to an account held by the receiving party.

7. The system of claim 1, wherein the packaged web-based payment data is in a manual entry format when information for the web-based payment card is manually entered to generate the payment request and in a swiped entry format when information for the web-based payment card is automatically gathered by a point-of-sale device to generate the payment request, and wherein each of the manual entry format and the swiped entry format has a plurality of fields, each field including information about the web-based payment card, and the swiped entry format has more fields than the manual entry format.

8. A financial transaction routing method, comprising:
generating, by a global network payment computing system, a web-based payment card, wherein the global network payment computing system is operated by a merchant with which a customer has a preexisting relationship, wherein the global network payment system is not associated with an issuer identification number,
wherein generating the web-based payment card comprises appending a web-based payment card prefix corresponding to a URL address associated with the global network payment system to an account number associated with a customer account that the customer holds with the merchant;
receiving, by the computing system, via the URL address, an electronic transaction record routed to the URL address from a financial transaction router, wherein the web-based payment card prefix directs the financial transaction router to route the electronic transaction record to the URL address, wherein the electronic transaction record is associated with a payment request from a customer associated with the customer account as part of a financial transaction between the customer and the merchant, and wherein the electronic transaction record includes packaged web-based payment data, the packaged web-based payment data including at least the web-based payment card prefix and the account number comprised in the web-based payment card;
identifying, by the computing system, the customer account based on the electronic transaction record; and
processing, by the computing system, the payment request from the customer account based on the electronic transaction record routed to the URL address.

9. The method of claim 8, wherein the customer can use the web-based payment card to make payments with preexisting payment card transaction systems.

10. The method of claim 8, wherein the web-based payment card prefix is one of the URL address, an IP address, a hexadecimal code, an encrypted URL address, or an encrypted IP address.

11. The method of claim 8, further comprising embodying, by the computing system, the web-based payment card in at least one of a physical implement, a database, or a digital device, wherein the customer can use the embodied web-based payment card to make payments with preexisting payment card transaction systems.

12. The method of claim 8, wherein the customer account is a financial account, and wherein processing the payment comprises:
transmitting, by the computing system, a payment authorization to one of a point-of-sale device or an online checkout system used by the customer to request the payment; and
transferring, by the computing system, funds from the customer account to an account held by the receiving party.

13. The method of claim 8, wherein the customer account is a rewards account containing one or more digital rewards items, and wherein the processing the payment comprises:
transmitting, by the computing system, a payment authorization to one of a point-of-sale device or an online checkout system used by the customer to request the payment;
modifying, by the computing system, one or more digital rewards items in the customer account; and
transferring, by the computing system, funds from an account associated with the computing system or the customer account to an account held by the receiving party.

14. The method of claim 8, wherein the packaged web-based payment data is in a manual entry format when information for the web-based payment card is manually entered to generate the payment request and in a swiped entry format when information for the web-based payment card is automatically gathered by a point-of-sale device to generate the payment request, and wherein each of the manual entry format and the swiped entry format has a plurality of fields, each field including information about the web-based payment card, and the swiped entry format has more fields than the manual entry format.

15. A system for financial transaction routing, comprising:
a server system associated with a financial transaction router, including a processor and a memory having instructions stored in non-transitory machine-readable media, the instructions executable by the processor to:
receive an electronic transaction record from one of a point-of-sale device or an online checkout system,
wherein the electronic transaction record is associated with a payment request from a customer as part of a financial transaction between the customer and a receiving party,
wherein the electronic transaction record includes packaged web-based payment data, the packaged web-based payment data including at least a web-based payment card prefix corresponding to a global network payment system and an account number associated with a customer account that the customer holds with a merchant, the web-based payment card prefix being appended to the account number,
wherein the global network payment system is operated by the merchant, wherein the global network payment system is not associated with a preexisting payment card prefix, and wherein the global network payment system is not associated with an issuer identification number, and
wherein the web-based payment card prefix is a URL address associated with the global network payment system;
decode the web-based payment card prefix from the electronic transaction record, wherein the decoded web-based payment card prefix directs the financial transaction router to route the electronic transaction record to the URL address associated with the global network payment system;
and
transmit the electronic transaction record to the URL address associated with the global network payment system.

16. The system of claim 15, wherein the server system is part of a preexisting payment card transaction system.

17. (canceled)

18. The system of claim 15, wherein the server system identifies the global network payment system based entirely on the web-based payment card prefix.

19. The system of claim 15, wherein the server system identifies the global network payment system by looking up an association between the web-based payment card prefix and the global network payment system in a routing database.

20. The system of claim 15, wherein the packaged web-based payment data is in a manual entry format when information for a web-based payment card comprising the web-based payment card prefix appended to the account number is manually entered to generate the payment request and in a swiped entry format when information for the web-based payment card is automatically gathered by a point-of-sale device to generate the payment request, and wherein each of the manual entry format and the swiped entry format has a plurality of fields, each field including information about the web-based payment card, and the swiped entry format has more fields than the manual entry format.
